(19) United States
(12) Patent Application Publication
(10) Pub. No.: US 2014/0256339 A1
(43) Pub. Date: Sep. 11, 2014

(54) APPARATUS AND METHOD FOR TRANSMITTING DATA BASED ON COOPERATION OF DEVICES FOR SINGLE USER

(71) Applicant: SAMSUNG ELECTRONICS CO., LTD., Suwon-si (KR)

(72) Inventors: Jong Bu LIM, Yongin-si (KR); Kyung Hun JANG, Suwon-si (KR)

(73) Assignee: SAMSUNG ELECTRONICS CO., LTD., Suwon-si (KR)

(21) Appl. No.: 14/099,347

(22) Filed: Dec. 6, 2013

(30) Foreign Application Priority Data
Mar. 11, 2013 (KR) 10-2013-0025698

(51) Int. Cl. H04W 72/04

(52) U.S. Cl. CPC H04W 72/048
USPC 455/452.1; 455/556.1

(57) ABSTRACT

A method of transmitting data using devices for a single user, the devices including a master device being in a used state and at least one slave device being adjacent to the master device and in an idle state, includes identifying devices for a single user, the devices comprising a master device in a used state and at least one slave device in an idle state; calculating, at a base station, a data transmission rate based on information received from the devices; and transmitting data to the devices according to the data transmission rate.

### CROSS-REFERENCE TO RELATED APPLICATIONS

This application claims the benefit under 35 USC §119(a) of Korean Patent Application No. 10-2013-0025698, filed on Mar. 11, 2013, in the Korean Intellectual Property Office, the entire disclosure of which is incorporated herein by reference for all purposes.

### BACKGROUND

1. Field

The following description relates to a base station, a master device, a slave device for transmitting data based on cooperation of devices for a single user, and methods thereof.

2. Description of Related Art

Use of various wireless devices including a smart phone and a tablet personal computer (PC) is rapidly increasing. Individual persons and households are using a plurality of personal wireless devices. However, receiving a plurality of streams or receive data with higher quality is difficult for such devices due to a lack of antennas in comparison to a base station or an access point (AP).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method of transmitting data, the method including identifying devices for a single user, the devices comprising a master device in a used state and at least one slave device in an idle state; calculating, at a base station, a data transmission rate based on information received from the devices; and transmitting data to the devices according to the data transmission rate.

The identifying of the devices for a single user may include identifying the devices for a single user based on information received from the master device.

The master device and the at least one slave device may communicate with the base station through a first communication network and may communicate with each other through a second communication network.

The first communication network may use a different communication method from a communication method of the second communication network.

The first communication network and the second communication network may use wireless resources orthogonal to each other when the first communication network and the second communication network use a same communication method.

The first communication network may include at least one of a cellular network, a wireless local area network (WLAN), a wireless personal area network (WPAN), or a wireless fidelity (WiFi), and the second communication network may include at least one of a cellular network, WLAN, WPAN, WiFi, Bluetooth, Zigbee, near field communication (NFC), or wireless gigabit alliance (WiGig).

In another general aspect, there is provided a method of transmitting data, the method including receiving, at a device, first data from a base station through a first communication network; receiving, at the device, second data from at least one slave device which cooperate, through a second communication network; collecting the first data and the second data; and decoding the collected first data and second data.

The method may also include identifying the at least one slave device being in an idle state; and transmitting information on the at least one slave device to the base station.

In another general aspect, there is provided a method of transmitting data, the method including receiving data from a base station through a first communication network; and forwarding information related to the data to a master device through a second communication network.

The forwarding may include forwarding the information related to the data without decoding the information.

The method may include quantizing the information related to the data; and the forwarding comprises forwarding the quantized information to the master device.

The method may include compressing the quantized information; and the forwarding comprises forwarding the compressed information to the master device.

The compressing of the quantized information may include compressing the quantized information based on source coding.

The information related to the data includes at least one of the data, information on the data, information on a channel used for receiving the data, or information on a reception state of the data.

The first communication network may use a different communication method from a communication method of the second communication network.

In another general aspect, there is provided a device for transmitting data including a recogniser configured to recognize at least one slave device that is in idle state among devices for a single user; a transmitter configured to transmit information about the at least one slave device to a base station; a receiver configured to receive first data from a base station and a second data from at least one slave device; and a collector configured to collect the first data and the second data.

The device may include a decoder configured to decode the first data and the second data.

The recogniser may be further configured to collect information on the at least one slave device.

The device and the at least one slave device may communicate with the base station through a first communication network and may communicate with each other through a second communication network.

Other features and aspects will be apparent from the following detailed description, the drawings, and the claims.

### BRIEF DESCRIPTION OF THE DRAWINGS

FIG. 1 is a diagram illustrating an example of increasing a transmission rate by transmitting data based on cooperation of devices for a single user.

FIG. 2 is a diagram illustrating an example of a data transmission method of a base station based on cooperation of devices for a single user.

FIG. 3 is a diagram illustrating an example in which a cellular communication network is used for global connectivity in a data transmission method based on cooperation of devices for a single user.

FIG. 4 is a diagram illustrating an example in which wireless fidelity (WiFi) wireless resources are used for global connectivity in a data transmission method based on cooperation of devices for a single user.

FIG. 5 is a diagram illustrating an example of a data transmission method of a master device based on cooperation of devices for a single user.

FIG. 6 is a diagram illustrating an example of a method of processing a data packet in a master device that is a destination, according to a data transmission method based on cooperation of devices for a single user.

FIG. 7 is a diagram illustrating an example of a data transmission method of a slave device based on cooperation of devices for a single user.

FIG. 8 is a diagram illustrating an example of a base station that transmits data based on cooperation of devices for a single user.

FIG. 9 is a diagram illustrating an example of a master device that transmits data based on cooperation of devices for a single user.

FIG. 10 is a diagram illustrating an example of a slave device that transmits data based on cooperation of devices for a single user.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

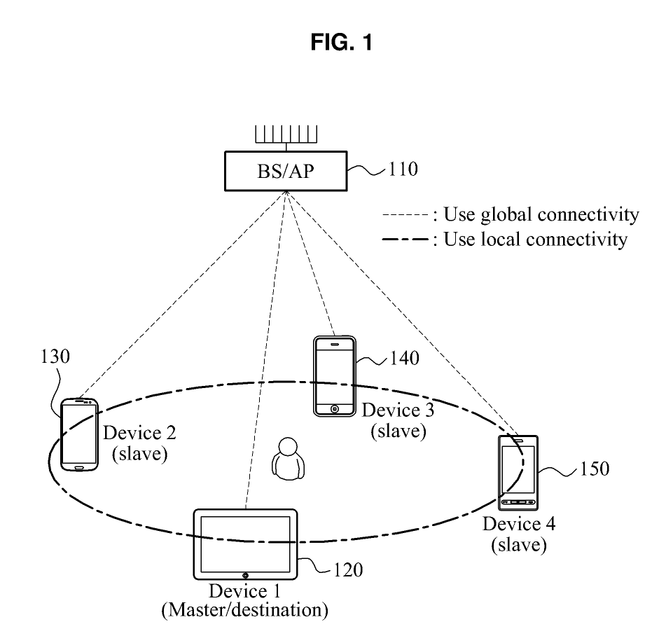

FIG. 1 illustrates an example of increasing a transmission rate by transmitting data based on cooperation of devices for a single user. Referring to FIG. 1, devices 120, 130, 140, and 150 for a single user may communicate with an access point (AP) 110 using global connectivity and communicate with one another using local connectivity. As a non-exhaustive illustration only, “devices for a single user” described herein may refer to devices such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a netbook, a tablet personal computer (tablet), a phablet, a personal digital assistant (PDA), a digital camera, a portable game console, an MP3 player, a portable/personal multimedia player (PMP), a digital multimedia broadcasting, a handheld e-book, an ultra mobile personal computer (UMPC), a portable lab-top PC, a global positioning system (GPS) navigation, and devices such as a high definition television (HDTV), an optical disc player, a DVD player, a Blue-ray player, a setup box, or any other device capable of wireless communication or network communication consistent with that disclosed herein, and which belongs to a user, is used for the convenience of the user, or is located in the household of the user.

For global connectivity, communication method, such as, for example, a cellular network, a wireless local area network (WLAN), a wireless personal area network (WPAN), and a wireless fidelity (WiFi) may be used. For local connectivity, communication method, such as, for example, cellular network, WLAN, WPAN, WiFI, Bluetooth, Zigbee, near field communication (NFC), and wireless gigabit alliance (WiGig) may be used.

The devices for a single user may be located at similar distances from a base station or the AP 110, which is a transmission end, and in similar environments. Therefore, channel states between the devices 120, 130, 140, and 150 and the base station or the AP 110 may also be similar. Although the devices 120, 130, 140, and 150 individually decode data received from the base station or the AP 110, similar packet error ratios may be obtained. The transmission rate may be increased by increasing a degree of freedom (DoF) or a diversity gain so that additional data streams may be transmitted, using various wireless devices belonging to individual persons or homes.

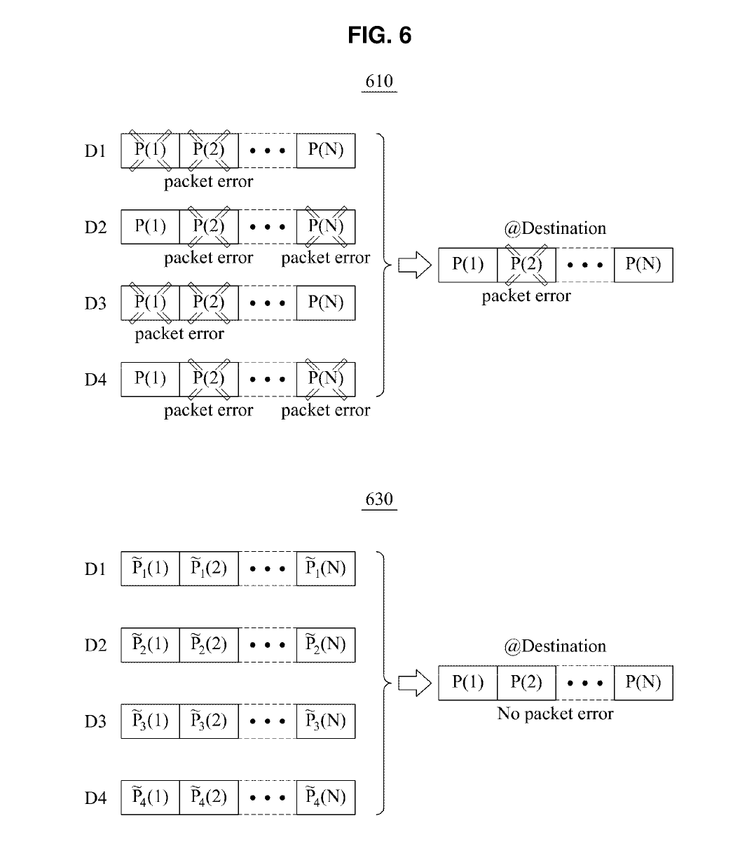

The devices 120, 130, 140, and 150 for a single user having less antennas than the transmission end, such as the base station or the AP 110, may operate as if much more antennas were provided, by operating in a cooperation nodes that perform communication in cooperation, Thus, each of the devices 120, 130, 140, and 150 may receive a large number of data streams or may receive more data by a higher signal to noise ratio (SNR). For this, a method of processing a data stream or data packet in a master device will be described with reference to FIG. 6.

In a non-exhaustive example, out of the devices 120, 130, 140, and 150 for a single user, the device 120 currently in use may be referred to as the “master device,” and the other devices 130, 140, and 150 located adjacent to the master device and staying in an idle state may be referred to as “slave device.” In the present non-exhaustive example, device 120 is referred to as the “master device” and devices 130, 140, and 150 are referred to as the “slave device,” but it will be apparent to one of ordinary skill in the art that any of the devices for a single user may be used as either the master or the slave device without departing from the spirit and scope of the illustrative examples described.

Here, a “used state” may be understood as a state in which the master device 120 receives data by requesting the base station or the AP 110 for data or information. The “used state” may also be understood as a state in which the base station or the AP 110 transmits data by setting the master device 120 as a destination. In addition, the “idled state” may be understood as a state in which the data received from the base station or the AP 110 is received without a subjective operation or request.

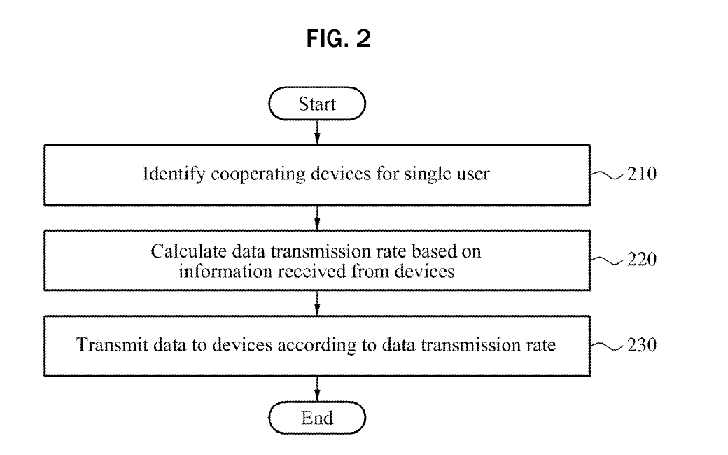

FIG. 2 is a diagram illustrating an example of a data transmission method of a base station based on cooperation of devices for a single user. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently. Moreover, the operation of the base station described hereinafter may be performed in the same manner by an AP.

Referring to FIG. 2, in 210, the base station may identify devices for a single uses, these devices may cooperate with each other. In a non-exhaustive example, the devices for a single user may include a master device being in the used state and at least one slave device being adjacent to the master device and in the idle state.

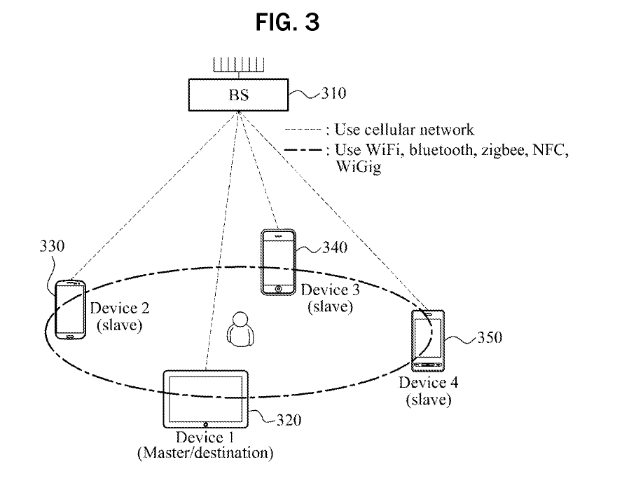

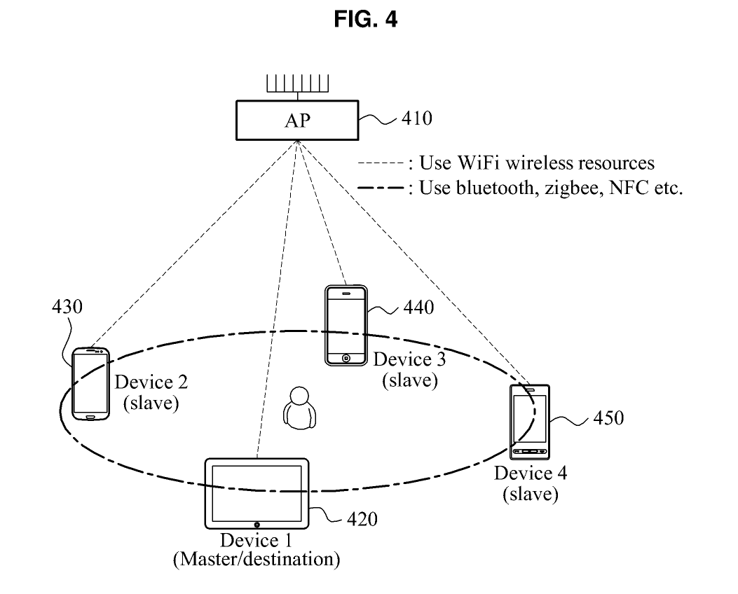

The master device and at least one slave device may communicate with a base station through a first communication network for global connectivity and communicate with each other through a second communication network for local connectivity. A non-exhaustive example related to communication of the master device and the at least one slave device through the first communication network and the second communication network will be described with reference to FIGS. 3 and 4.

In 210, the base station may recognize the presence of at least one slave device adjacent to the master device by itself or the base station may receive corresponding information from the master device. The base station may identify the devices for a single user, which cooperate, using the information related to the at least one slave device received from the master device.

In 220, the base station may calculate a data transmission rate based on the information received from the devices identified in 210.

In 230, the base station may transmit data to the devices for a single user, which cooperate, according to the data transmission rate calculated in 220. The base station may transmit data to be delivered to the master device, which is a final destination. However, information transmitted from the base station through a wireless channel may be transmitted to both the master device and the slave device connected with the base station through global connectivity.

FIG. 3 is a diagram illustrating an example in which a cellular communication network is used for global connectivity in a data transmission method based on cooperation of devices for a single user. Referring to FIG. 3, a base station 310 and devices 320, 330, 340, and 350 for a single user, which cooperate, may use a communication method, such as, for example, a cellular network as a first communication network for global connectivity. Any communication method, such as, for example, WiFi, Bluetooth, Zigbee, NFC, or WiGig may be used as a second communication network for local connectivity.

The first communication network and the second communication network may use different communication methods. When the first communication network and the second communication network use a same communication method, the first communication network and the second communication network may communicate using wireless resources orthogonal to each other. For example, when the first communication network is a cellular network and the second communication network is also a cellular network, the first communication network may use wireless resources of the cellular network orthogonal to the second communication network.

FIG. 4 is a diagram illustrating an example in which WiFi wireless resources are used for global connectivity in a data transmission method based on cooperation of devices for a single user. Referring to FIG. 4, an AP 410 and devices 420, 430, 440, and 450 for a single user, which cooperate, may use the WiFi wireless resources as a first communication network for global connectivity. Besides the WiFi, various other wireless communication methods may be used as the first communication network. Any communication method, such as, for example, Bluetooth, Zigbee, NFC, or WiGig may be used as a second communication network for local connectivity.

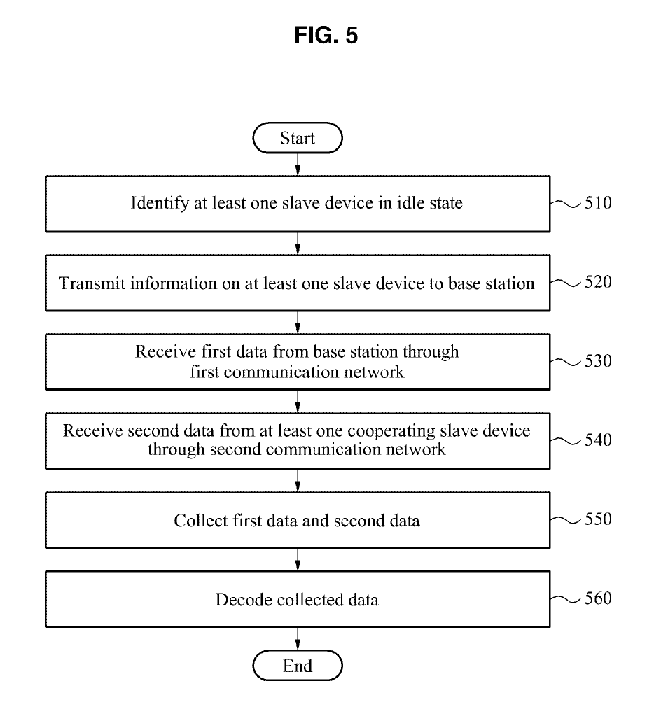

FIG. 5 is a diagram illustrating an example of a data transmission method of a master device based on cooperation of devices for a single user. The operations in FIG. 5 may be performed in the sequence and manner as shown, although the order of some operations may be changed or some of the operations omitted without departing from the spirit and scope of the illustrative examples described. Many of the operations shown in FIG. 5 may be performed in parallel or concurrently. Moreover, the operation of the base station described hereinafter may be performed in the same manner by an AP.

Referring to FIG. 5, in 510, according to a non-exhaustive example, the master device may identify at least one slave device being in an idle state. In 520, the master device may transmit information related to the at least one slave device to a base station. The base station may identify the at least one slave device located adjacent to the master device, based on the information related to the at least one slave device received from the master device. In addition, the base station may transmit data to the master device and the slave device through the first communication network. The data may be transmitted based on a data transmission rate calculated based on the information received from the identified device.

In 530, the master device may receive first data from the base station through the first communication network. In 540, the master device may receive second data from at least one cooperating slave device through a second communication network. In 550, the master device may collect the first data directly received from the base station in 530 and the second data received from the slave device in 540.

In 560, the master device may decode the information collected in 550. A non-exhaustive example of a decoding method of the master device will be described with reference to FIG. 6.

FIG. 6 is a diagram illustrating an example of a method of processing a data packet in a master device that is a destination, according to a data transmission method based on cooperation of devices for a single user. In the non-exhaustive example if FIG. 6, the master device or the destination is denoted as “@Destination” and the slave devices are shown as D1, D2, D3, and D4. FIG. 6 illustrates two methods of decoding the packet blocks or data frames. In 610, the packet blocks or data frames are decoded in individual devices and the decoded packet blocks or data frames are transmitted to the master device. In 630, the master device decodes the the packet blocks or data frames, which are transmitted through the respective individual devices.

As shown in the method 610, when an error occurs in packets located in similar positions among the transmitted packet blocks, the packet error may still remain even though the devices cooperate to transmit decoded information to a final destination node such as the master device.

Therefore, according to a non-exhaustive example, the devices for a single user to transmit the packet blocks may be considered as cooperation nodes. As shown in the method 630, the cooperative nodes communicate so that the devices, such as the at least one slave device, may transmit the received information, such as the packet blocks or data frames, to the master device, which is the final destination node, without decoding. The master device may decode the packet blocks received from the devices, thereby securing packets without errors.

In method 630, the information transmitted by the devices to the master device may include information on a channel through which each device receives the packet blocks or data frames or information on a reception state of the packet. Since the information transmitted by the at least one slave device to the master device is almost in an analog type, an amount of data to be transmitted may be large. Therefore, the at least one slave device may compress the information to be transmitted by compression algorithm, such as, for example source coding, for more efficient transmission of the information. When the devices for a single user perform cooperative communication, the transmission rate may increase as a number of the devices increases.

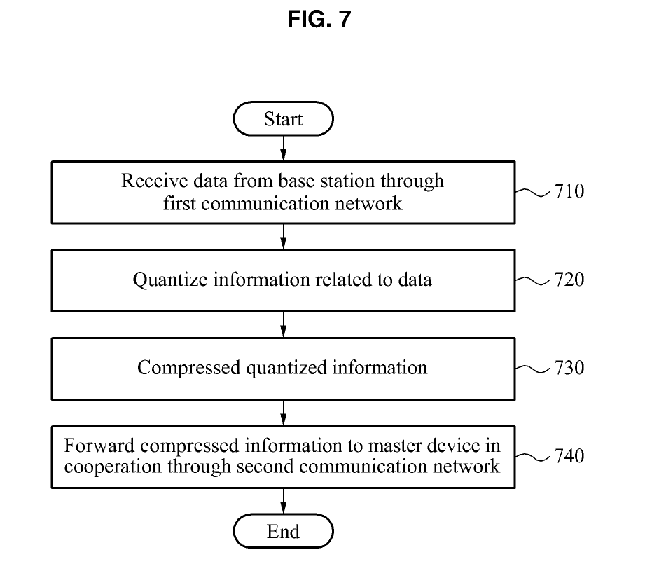

FIG. 7 is a diagram illustrating an example of a data transmission method of a slave device based on cooperation of devices for a single user. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. Moreover, the operation of the base station described hereinafter may be performed in the same manner by an AP.

Referring to FIG. 7, in 710, the slave device may receive data from a base station through a first communication network. The slave device may forward information related to the data to a master device, which cooperates through a second communication network. Here, the slave device may forward the information to the master device without decoding the information as described in method 630.

In 720, the slave device may quantize the information related to the data. The information related to the data may include at least one selected from the data, information on the data, information on a channel used for receiving the data, or information on a reception state of the data.

In 730, the slave device may compress the information quantized in 720. In 730, the slave device may compress the information using compression algorithm, such as, for example source coding.

In 740, the slave device may forward the information compressed in 730 to the master device, which cooperates through the second communication network.

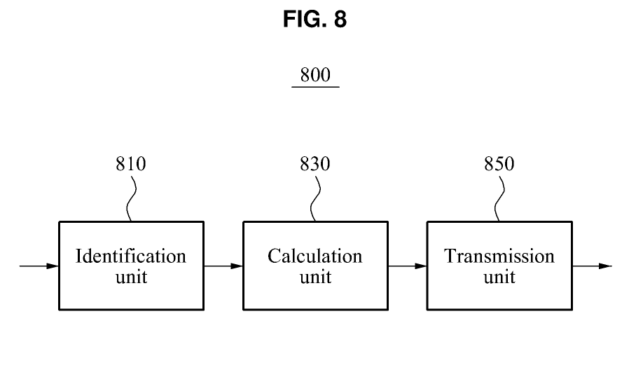

FIG. 8 is a diagram illustrating an example of a base station 800 that transmits data based on cooperation of devices for a single user. Referring to FIG. 8, the base station 800 includes an identification unit 810, a calculation unit 830, and a transmission unit 850. The identification unit 810 may identify devices for a single user, the devices that cooperate.

The identification unit 810 may recognize the presence of at least one slave device adjacent to a master device by itself or it may receive corresponding information from the master device. In a non-exhaustive example, the identification unit 810 may identify the devices for a single user using information related to the at least one slave device, which is received from the master device.

The calculation unit 830 may calculate a data transmission speed or rate of the data to be transmitted to the master device, based on the information received from the cooperating devices for a single user, identified by the identification unit 810. The transmission unit 850 may transmit the data to the cooperating devices for a single user, including the master device.

The devices for a single user may include the master device in a used state and at least one slave device being adjacent to the master device and in an idle state. The ‘used state’ refers to a state in which the master device receives data by requesting a base station for the data or information, or in which the base station transmits the data by setting the master device as a destination. The ‘idled state’ may be understood as a state in which the data received from the base station is only received without a subjective operation or request.

The master device and the at least one slave device may communicate with the base station through a first communication network. The master device and the at least one slave device may communicate with one another through a second communication network. The first communication network and the second communication network have been described above, and the first communication network may use a different communication method from a communication method of the second communication network. For example, the first communication network may include any one selected from the cellular network, WLAN, WPAN, and WiFi. The second communication network may include any one selected from the cellular network, WLAN, WPAN, WiFi, Bluetooth, Zigbee, NFC, and WiGig. When the first communication network uses the same communication method as the second communication network, the first communication network and the second communication network may use wireless resources orthogonal to each other. For example, when the first communication network and the second communication network use the same cellular network, the second communication network may use wireless resources orthogonal to the first communication network.

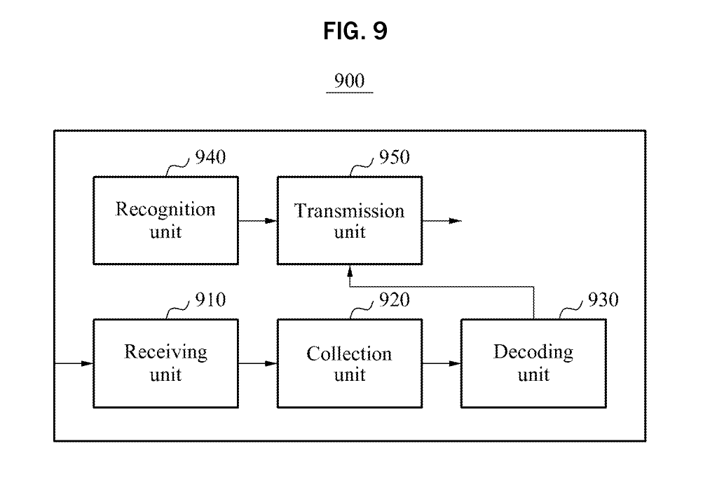

FIG. 9 is a diagram illustrating an example of a master device 900 that transmits data based on cooperation of devices for a single user. Referring to FIG. 9, the master device 900 may include a receiving unit 910, a collection unit 920, a decoding unit 930, a recognition unit 940, and a transmission unit 950.

The receiving unit 910 may receive first data from a base station through a first communication network, and receive second data from at least one slave device cooperating with the master device 900 through a second communication network. The collection unit 920 may collect the first data and the second data received through the receiving unit 910. The decoding unit 930 may decode the information collected by the collect unit 920.

The recognition unit 940 may recognize the at least one slave device being in the idle state, among the devices for a single user forming local connectivity through the second communication network. The master device may collect information on peripheral idle devices recognized by the recognition unit 940, i.e., the slave devices. The transmission unit 950 may transmit, to the base station, the information collected with respect to at least one slave device recognized by the recognition unit 940.

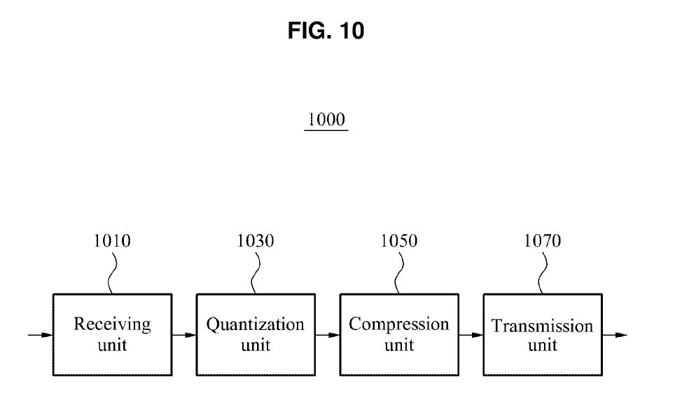

FIG. 10 is a diagram illustrating an example of a slave device 1000 that transmits data based on cooperation of devices for a single user. Referring to FIG. 10, the slave device 1000 may include a receiving unit 1010, a quantization unit 1030, a compression unit 1050, and a transmission unit 1070.

The slave device 1000 that received data from a base station through a first communication network may forward information related to the data to the master device that cooperates through a second communication network. The slave device 1000 may forward the information related to the data to the master device, without decoding the information.

In a non-exhaustive example, the slave device 1000 may quantize the information through the quantization unit 1030 and compress the quantized information through the compression unit 1050. The compression unit 1050 may compress the quantized information using compression algorithm, such as, for example source coding. The transmission unit 1070 may transmit the compressed information to the master device.

In another non-exhaustive example, when a channel capacity between the master device and the slave device 1000 is sufficient, the transmission unit 1070 may transmit the information related to reception of the data from a base station directly to the master device, which is a final destination node through the first communication network, without compressing the information.

The devices for a single user receive a plurality of data streams simultaneously, by cooperating with one another. As a result, a transmission rate may be increased. In addition, a diversity gain may be provided to devices that cannot receive data by a desired data transmission rate due to poor positions for a channel state, through the cooperation of the devices for a single user.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of transmitting data, the method comprising:
identifying devices for a single user, the devices comprising a master device in a used state and at least one slave device in an idle state;
calculating, at a base station, a data transmission rate based on information received from the devices; and
transmitting data to the devices according to the data transmission rate.

2. The method of claim 1, wherein the identifying of the devices for a single user comprises identifying the devices for a single user based on information received from the master device.

3. The method of claim 1, wherein the master device and the at least one slave device communicate with the base station through a first communication network and communicate with each other through a second communication network.

4. The method of claim 3, wherein the first communication network uses a different communication method from a communication method of the second communication network.

5. The method of claim 3, wherein the first communication network and the second communication network use wireless resources orthogonal to each other when the first communication network and the second communication network use a same communication method.

6. The method of claim 3, wherein:
the first communication network comprises at least one of a cellular network, a wireless local area network (WLAN), a wireless personal area network (WPAN), or a wireless fidelity (WiFi), and
the second communication network comprises at least one of a cellular network, WLAN, WPAN, WiFi, Bluetooth, Zigbee, near field communication (NFC), or wireless gigabit alliance (WiGig).

7. A method of transmitting data, the method comprising:
receiving, at a device, first data from a base station through a first communication network;
receiving, at the device, second data from at least one slave device which cooperate, through a second communication network;
collecting the first data and the second data; and
decoding the collected first data and second data.

8. The method of claim 7, further comprising:
identifying the at least one slave device being in an idle state; and
transmitting information on the at least one slave device to the base station.

9. A non-transitory computer readable recording medium storing a program to cause a computer to execute the method of claim 7.

10. A method of transmitting data, the method comprising:
receiving data from a base station through a first communication network; and
forwarding information related to the data to a master device through a second communication network.

11. The method of claim 10, wherein the forwarding comprises forwarding the information related to the data without decoding the information.

12. The method of claim 10, further comprising:
quantizing the information related to the data; and
the forwarding comprises forwarding the quantized information to the master device.

13. The method of claim 12, further comprising:
compressing the quantized information; and
the forwarding comprises forwarding the compressed information to the master device.

14. The method of claim 13, wherein the compressing of the quantized information comprises compressing the quantized information based on source coding.

15. The method of claim 10, wherein the information related to the data comprises at least one of the data, information on the data, information on a channel used for receiving the data, or information on a reception state of the data.

16. The method of claim 10, wherein the first communication network uses a different communication method from a communication method of the second communication network.

17. A device for transmitting data comprising:
a recogniser configured to recognize at least one slave device that is in idle state among devices for a single user;
a transmitter configured to transmit information about the at least one slave device to a base station;
a receiver configured to receive first data from a base station and a second data from at least one slave device; and
a collector configured to collect the first data and the second data.

18. The device of claim 17, further comprising a decoder configured to decode the first data and the second data.

19. The device of claim 17, wherein the recogniser is further configured to collect information on the at least one slave device.

20. The device of claim 17, wherein the device and the at least one slave device communicate with the base station through a first communication network and communicate with each other through a second communication network.
